(19) United States
(12) Patent Application Publication
(10) Pub. No.: US 2002/0160264 A1
(43) Pub. Date: Oct. 31, 2002

(54) Collector plates for bipolar electrodes of lead batteries

(75) Inventors: Guy Bronoel, Versailles (FR); Noelle Tassin, Fontenay-Sous-Bois (FR)

Correspondence Address: HENDERSON & STURM LLP, 1213 MIDLAND BUILDING, 206 SIXTH AVENUE, DES MOINES, IA, 50309-4076, US

(73) Assignee: SORAPEC

(21) Appl. No.: 09/736,539

(22) Filed: Dec. 13, 2000

Related U.S. Application Data
(63) Continuation of application No. PCT/FR99/01410, filed on Jun. 15, 1999.

(30) Foreign Application Priority Data
Jun. 19, 1998 (FR) 98.07740

(51) Int. Cl. H01M 4/74; H01M 4/68

(52) U.S. Cl. 429/210; 429/234; 429/241; 429/245

(57) ABSTRACT

The invention concerns a composite plate for Pb/PbO₂ batteries with bipolar electrodes, characterized by unidirectional electronic conduction provided by metal wires made at least at the surface of lead or lead alloy, arranged in a regular array and coated with a polymer, stable in an acid medium and capable of generating a strong bonding with the lead or lead alloy constituting the wire surface—the wire volume representing only at most 4% of the plate total volume at most. Hence the mass per unit area thereof remains of the order of 15 g/km².

The present invention relates to a method for the production of composite plates for Pb—PbO₂ batteries with bipolar electrodes, in which plates electronic conduction is provided by wires which are constituted at least on their surfaces by lead or lead alloy, and are disposed according to a regular array, perpendicularly to the surfaces of the plate, these wires being coated by a polymer which is stable in an acid medium, and can create a strong bond with the metal or alloy which constitutes the wires, the total volume of the conductor wires being less than 4% of the total volume of the plate.

Many attempts have been made to produce conductor plates, which are designed for the production of bipolar electrodes for Pb/PbO₂ batteries. The essential problem consists in obtaining a significant reduction in weight, compared with the standard architectural elements, whilst assuring a long cycle life. Thus, the use has been proposed of intrinsically conductive polymers such as polyanilines, or the use of fibres of different oxides, such as, among others, SnO₂, included in an isolating material. These new materials often have insufficient electronic conduction, their cost is high, and their stability is unreliable.

Also, more recently, several inventions have been aimed at the use of lead or its alloys as the conductive element of the plate. From this point of view, the most simple case consists of using a thin sheet of lead or one of its alloys. However, for thicknesses of a few tens of millimeters, the mechanical strength is insufficient; it is therefore necessary to place the thin sheet between two grids made of polymer, which, in addition, assure retention of the active materials, whilst strengthening the assembly. After a few tens of charging-discharging cycles, a solution of this type leads to perforations of the sheet of lead, when the latter has a thickness of less than 0.4 mm. However, the use of greater thicknesses is disadvantageous in terms of reducing the weight of the bipolar electrodes; for 0.5 mm, the weight of the plate is approximately 55 g/dm².

Another system (PCT Publication No. WO 97/23917 of Nov. 12, 1996) consists of using a plate which is rendered conductive, by adding powdered lead or one of its alloys to the polymer. In this case, taking into account the content of powder necessary in order to obtain sufficient conductivity by percolation, it is found that the weight of the plate is again greater than 30 g/dm².

Other solutions consist of producing a composite plate, characterised in that a fibrous structure made of polymer is rendered conductive by filling its porosity by lead or a lead alloy (French Patent No. 2 662 536 of Oct. 14, 1991). In this case, filling of the entire porosity is a difficult, costly operation, and the sealing obtained by means of the electrolyte is random.

Other solutions have been envisaged, for which the bipolar plate consists of a polymer-metal composite material, the electronic conduction being assured by the metal, which is used either in the form of fibres or in the form of pins, which pass through the polymer material. In the case of use of metal fibres which pass through the polymer plate (Japanese Patent No. 56 149776 of Nov. 19, 1981), the distribution of the conductive fibres is not regular, and the distance to be travelled by the electrical charges is not constant, since the fibres are not parallel to one another. Japanese Patent No. 59 121787 of Dec. Jul. 13, 1984 constitutes a significant improvement compared with the case of use of metal fibres, since it describes a bipolar collector which consists of a substrate made of resin, through which there pass metal pins, the ends of which project on both sides; the method for production of this bipolar wall consists of perforating a substrate made of resin based on polypropylene and inserting metal pins in the holes. The following step consists of shaping the ends of the pins according to three different shapes, which leads to a method which is complicated at the industrial stage, and is thus costly. In addition, the method for introduction of the metal pins into the holes of the support does not make it possible to create an efficient bond between the metal and the resin, and leakages of acid electrolyte are liable to occur on both sides of the bipolar wall, thus creating shunt currents between the different unitary cells of the bipolar battery.

The object of the present invention is a composite plate and methods for production of plates of this type, which do not have the above-described disadvantages.

The optimal structure of the plate has been determined, on the basis of obtaining a significant reduction in weight, satisfactory conductivity, and good sealing against the electrolyte.

The conductive plate according to the invention, which is designed for Pb—PbO₂ batteries, is constituted of a plate made of a polymer which is stable in a sulphuric acid medium, in which there are inserted conductor wires, which are constituted at least on their surface by lead or lead alloy, are disposed perpendicularly to the surface of the said plate, and provide the electronic conduction.

From the point of view of electronic conduction characteristics of the plate, it has been proved that it is unnecessary to attempt to obtain conduction throughout the mass of the plate, provided that the conductive elements are distributed regularly, and this conduction is substantially one-way. Thus, even for surface current densities which are as high as 200 mA/cm², an ohmic drop in the plate lower than 3 mV can be obtained, for a thickness of the latter of 1 mm, and a volume of the metal conductor of approximately only 2% of the total volume of the plate (for conductor wires constituted of lead).

The elements which provide the conduction can be wires, the cross-section of which is advantageously, but not necessarily, circular, the said wires being disposed perpendicularly to the large surfaces of the plate. The regularity which is necessary in the arrangement of these wires must assure that the cross-sections which open onto the two surfaces of the plate are centred on the points of intersection of a regular array, the patterns of which are square, or, preferably, equilateral triangles. The optimal distance between centres of two conductive sections depends essentially on the characteristics of electronic conductivity of the active substances which cover the plate finely, and not on the conduction in the wires, provided that, for practical reasons of implementation, the latter have a diameter larger than 0.2 mm.

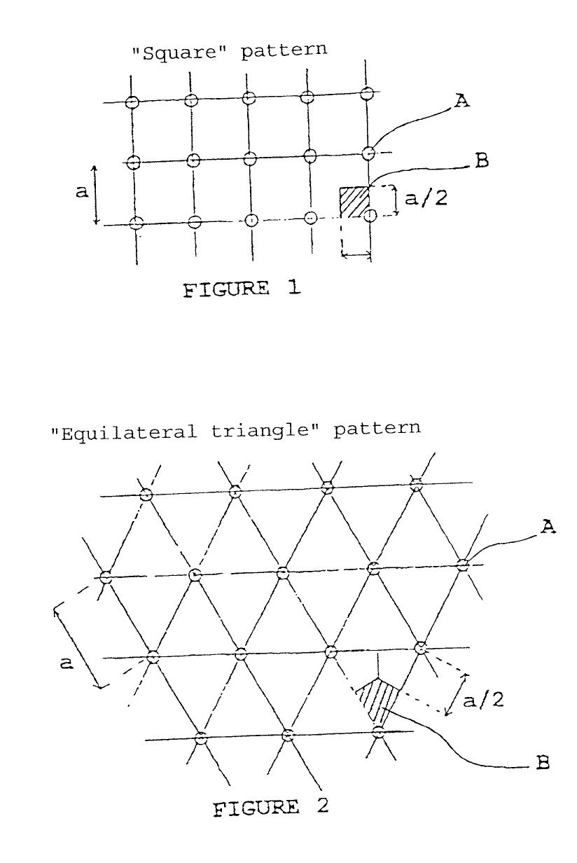

FIG. 1 shows an arrangement of the wires according to a square pattern, and

FIG. 2 shows an arrangement of the wires according to an equilateral triangle pattern.

We have shown that, owing to the regular patterns of distribution of the conductive elements, the ohmic resistance induced by draining of the charges in the active substance is independent of the spacing of these conductor wires (A). Thus, for a square pattern, it is found that:

$$R \sim 2 \frac{ρ}{e}$$

in which ρ is the resistivity of the active substance, and “e” is its thickness, and p varies with the condition of discharge of the active substance. In practice, the following experimental data will be obtained:

$$\frac{ρ}{e} = K$$

For an equilateral triangle pattern, it is found that:

$$R \sim \frac{4 ρ}{\sqrt{3} e}$$

However, the ohmic drop in the active substance is the product of R and the current, which affects a drainage sector (B) of the surface. If the surface current density is i, it is found that the voltage drop Δv associated with the charges is, for a square pattern:

$$Δ v \sim \frac{iaK}{4}$$

and for a triangular pattern it is:

$$Δ v \sim \frac{iaK}{6}$$

“a” being the distance which separates the centre of two adjacent wires.

In any case, the overall ohmic drop is the sum of the ohmic drop on each surface of the screen (positive and negative active substances), and of the ohmic drop in the wires which assure the electronic conduction from one surface towards the other. In fact, the drop in the wires is negligible, and the ohmic drop in the positive active substance is clearly preponderant compared with that for the negative active substance.

Analysis of the above-described ratios shows that:

Δv is proportional to “i”;

Δv varies as the square of the distance “a”; and

the triangular pattern leads to a lower ohmic drop than the square pattern.

This latter conclusion is associated with the fact that the arrangement according to equilateral triangles corresponds to the most compact filling of the space.

Taking into account the mid-discharge value of K (positive active substance), and that of the discharge applicable for a pre-defined surface capacity, by establishing a maximum Δv (for example 50 mV), it is thus possible to determine the parameter “a” which leads to this maximal ohmic drop. It is found that, in many cases, by providing “a” with a value of between 0.5 and 1.5 cm, the arrangement pattern being triangular, an ohmic drop which is not prohibitive is obtained.

The diameter of the conductor wires will be determined substantially by the facilities for obtaining a wire which has mechanical characteristics which are sufficient for the wire to be handled, in particular during the phase when it is put into contact with the polymer. If the weight of the metal conductors is required to remain lower than 25% of the total weight of the screen, and, if possible, is approximately 10% of the latter, it is found that, for distances between centres of the cross-sections of the wires of between 0.5 and 1.5 cm, the diameter of the wires will be between 0.5 and 1.5 mm; the diameter advantageously being able to be all the larger, the greater “a” is.

The diameter of the wires and the distance between centres of the cross-sections of the wires will be selected such that the total volume of the wires continues to be between 0.2% and 4% of the total volume of the plate.

In addition to the limitations which are associated with the method for application of the polymer, the thickness of the plate should be greater than a critical value, which has been determined by the behaviour in relation to oxidation of the lead or lead alloy which constitutes the surface of the wires. In fact, for very low thicknesses of the plate, and therefore a short length of the wire, of, for example, 0.2 mm, after the cycle has taken place (charging-discharging), oxidation of the wire is observed, such that, by means of the gaps, the electrolyte can then connect the two surfaces of the plate. This sealing defect is clearly unacceptable for satisfactory functioning of the bipolar electrode.

The studies carried out by us have shown that, on the other hand, even for small apparent surfaces of the lead which constitutes the wires (of approximately 2% of the total surface) a thickness greater than 0.5 mm makes it possible to prevent these risks for many cycles of charging and discharging. The plate will advantageously have a thickness of between 0.5 and 2 mm, and preferably 1 mm.

The length of the conductor wires can advantageously be slightly greater than the thickness of the plate, thus making it possible to assure perfect contact with the active substances. The overlap of the wires on each side of the plate is between 0.1 and 0.3 mm.

In fact, even at the end of charging (surcharging of the element), the current applied to the lead or lead alloy which constitutes the surface of the wires, represents only a small fraction of the total current, most of the current being applied to development of oxygen, and the oxides which cover the metallic lead or one of its alloys acting as a screen. In addition, the larger the contact surface between the wire and the polymer, the more risks of leakages caused by the existence of gaps are reduced.

Another important point according to this invention relates to the importance of the bond which must exist between the lead or one of its alloys which constitutes the surface of the wires, with the polymer which coats the latter. In fact, the object is to prevent detachment between the metallic wire and the polymer. Consequently, it has been found that it is preferable to select as the polymer an epoxy resin which is resistant in an acid medium, or ebonite.

In the case of an epoxy resin, the mixture will be cast in a mould before it is polymerised around the wires, which are arranged according to the pre-defined pattern.

In the case of ebonite, the hot mixture will be injected into a mould which contains the suitably arranged wires.

The wires which assure the electronic conduction consist either of pure lead, or of a lead alloy, for example Pb—Sn, Pb—Ca or Pb—Sb, or of a metal which is resistant to oxidation (for example 316L stainless steel), coated with a layer of lead or one of its aforementioned alloys.

In accordance with the details previously described, a plate 10 cm×10 cm and 1 mm thick was produced, with pure lead wires arranged according to a triangular pattern, the sides of which were 6 mm. The lead wires (with purity of 99.5%) had a diameter of 1 mm. The wires were arranged in a mould according to the aforementioned triangular pattern, and the following mixture was moulded between them: ARALDITE® AV138M+HV 998 hardener (CIBA). After polymerisation at a temperature of 50° C., the plate was removed from the mould, and its surface was prepared by means of slight abrasion.

This plate was partially covered on one of its surfaces with positive active material, the surface weight of which was such that the capacity rendered in 10 hours of discharge was 75 mAh/cm². The same procedure was used on the other surface, by covering with the negative active substance.

This electrode was placed in a screen between two compartments, each of which was filled with an aqueous solution of sulfuric acid with a concentration of 490 g/l. A positive electrode of PbO₂ was placed in one of these compartments, and a negative electrode of Pb was placed in the other. The part of the plate which was not covered by the active substances made it possible to assure sealing between the two compartments, by means of a seal.

After formation of the active substances of the electrodes according to a conventional method, this bi-element was subjected to successive charging and discharging as follows:

charging for 7.2 hours with a current equivalent to 2.7 A;

discharging for 6 hours with a current equivalent to 2.7A.

After 800 cycles, stable behaviour of the bi-element was still found, which proves the excellent stability of the bipolar plate, and consequently the preservation of its sealing qualities. In addition, it was also possible to measure that the weight of the bipolar plate was 15 g/dm² (before being coated by the active substances).

It will be appreciated that this example is simply an illustration of the invention, which is not limited to this embodiment, but includes all the variants.

1. Composite plate, designed for production of Pb/PbO₂ batteries with bipolar electrodes, characterised in that the electronic conduction is assured by metal wires, which are constituted at least on their surface by lead or lead alloy, and are disposed according to a regular array, perpendicularly to the surfaces of the plate, these wires being coated by a polymer which is stable in an acid medium, and can create a strong bond with the metal or the alloy which constitutes the surface of the wires, the total volume of the conductor wires being less than 4% of the total volume of the plate.

2. Composite plate according to claim 1, characterised in that the wires are arranged according to a regular array, the pattern of which is square or more advantageously centred hexagonal, the cross-section of each wire which opens onto the surface of the plate being centred, either at the top of a square, or at the top of an equilateral triangle.

3. Composite plate according to claim 2, characterised in that the squares or equilateral triangles which constitute the wire distribution array have sides of between 0.5 and 1.5 cm.

4. Composite plate according to claim 1, characterised in that the thickness of the plate is between 0.5 and 2 mm, and preferably 1 mm.

5. Composite plate according to claims 1 and 4, characterised in that the length of the conductor wires is equivalent to the thickness of the plate, i.e. it is between 0.5 and 2 mm, and preferably 1 mm.

6. Composite plate according to claims 1 and 4, characterised in that the conductor wires project from the plate on each of the surfaces, by a height of between 0.1 and 0.3 mm.

7. Composite plate according to claim 1, characterised in that the diameter of the wires is between 0.5 and 1.5 mm.

8. Composite plate according to claims 1, 2, 3 and 5, characterised in that the total volume of the wires is between 0.2% and 4% of the total volume of the plate.

9. Composite plate according to claim 1, characterised in that the polymer is ebonite.

10. Composite plate according to claim 1, characterised in that the polymer is an epoxy resin.

11. Composite plate according to claim 1, characterised in that the wires consist of pure lead.

12. Composite plate according to claim 1, characterised in that the wires consist of Pb—Sn alloy.

13. Composite plate according to claim 1, characterised in that the wires consist of Pb—Ca alloy.

14. Composite plate according to claim 1, characterised in that the wires consist of Pb—Sb alloy.

15. Composite plate according to claim 1, characterised in that the wires consist of stainless steel coated with lead or lead alloy.
